(19) United States
(12) Patent Application Publication
(10) Pub. No.: US 2004/0018378 A1
(43) Pub. Date: Jan. 29, 2004

(54) Marking film

(76) Inventor: Hideto Endoh, Yamagata (JP)

Correspondence Address: 3M INNOVATIVE PROPERTIES COMPANY, PO BOX 33427, ST. PAUL, MN, 55133-3427, US

(21) Appl. No.: 10/446,378

(22) Filed: May 28, 2003

(30) Foreign Application Priority Data
May 28, 2002 (JP) JP 2002-153466

(51) Int. Cl. B32B 9/00; B32B 19/00

(52) U.S. Cl. 428/689

(57) ABSTRACT

A marking film includes a vinyl chloride resin film containing a pigment and a stabilizer. The pigment contains vanadate, and the stabilizer contains an organotin compound, a hindered amine type light stabilizer and a metal soap. The film is free of discoloration and, when a protective film is laminated, is free from a decrease in the interlayer peel strength between the marking film and the protective film.

### CROSS REFERENCE TO RELATED APPLICATIONS

This application claims foreign priority from Japanese Application No. 2002-153466, filed May 28, 2002.

### BACKGROUND OF THE INVENTION

1. Field of the Invention

The present invention relates to a marking film and, more particularly, to a marking film of vinyl chloride resin.

2. Description of the Related Art

Marking films have been made from vinyl chloride resins, for example, and have been used for information display bodies by being adhered to signboards, guide plates, label boards, and the like. In many cases, such marking films have an adhesive layer provided on one surface and a protective film adhered to the other surface of the vinyl chloride resin film, so that the marking film can be attached to a signboard and the like via the adhesive layer and the exposed surface of vinyl chloride resin film can be protected by the protective film. The vinyl chloride resin film usually contains, in addition to the vinyl chloride resin, a stabilizer to improve weather resistance, a pigment to provide the film with a color, and the like.

Oxides, chromates, sulfides, silicates, phosphates, vanadates, and the like can be used as a pigments. Also, in recent years, the use of raw materials with higher safety has been sought for marking films in view of environmental protection, and pigments containing heavy metals such as lead and chromium have been replaced by other pigments. As for pigments containing metals other than lead and chromium, bismuth vanadate, which is a vanadate-based pigment, has been used. The bismuth vanadate is strongly colored providing a vivid color and, therefore, is useful as a yellow pigment replacing chrome yellow (a lead chromate compound). The use of bismuth vanadate pigment is disclosed in JP-A-10-114864 and JP-A-2001-220550, for example.

Addition of a stabilizer to vinyl chloride resin film to prevent deterioration of the film with elapse of time during its use as a marking film is well-known. There are several prior art documents disclosing stabilizers for vinyl chloride resin films as described below. However, there are no prior art documents that disclose stabilizers effective for improvement of a vinyl chloride resin film comprising a vanadate-containing pigment. For example, Practical Use Plastic Encyclopedia-edition for Raw Materials (Apr. 20, 1996, 3rd printing of first edition, issued by Industry-Research Association Co. Ltd.) describes that metal soap, organic tin-based stabilizers, lead-based stabilizers, epoxy compounds, β-diketones, phosphites, polyhydric alcohols, hindered amine light stabilizers (HALS), phenol-based anti-oxidants, and the like can be used as stabilizers for vinyl chloride resin.

JP-A-4-136054 discloses the use of a mixture of a zinc carboxylate (a metal soap containing zinc) and a stabilizer containing perchlorate. The patent document discloses that this stabilizer may further comprise an alkyl tin-based stabilizer or a hindered amine light stabilizer.

JP-A-5-214191 discloses a transparent formed article made from a vinyl chloride resin, a stabilizer for the vinyl chloride resin, and a photoluminescent pigment. The stabilizer used in this document comprises a tin stabilizer and a hindered amine light stabilizer. This stabilizer can suppress the luminance degradation rate of the formed article, whereby the article is provided with photoluminescent characteristics in which it can emit light for a longer period during one light-emission. The patent document does not disclose the use of a protective film applied to the surface of the transparent formed article.

WO 99/20688 discloses the use of a hindered amine as a stabilizer for vinyl chloride resin containing a fluorescent pigment.

JP-A-9-314792 discloses a weather resistant olefin-based sheet having a colored shielding layer containing vinyl chloride resin and a stabilizer therefor and having a transparent olefin-based resin layer covering the colored shielding layer. The transparent olefin-based resin layer contains a hindered amine stabilizer and the stabilizer for vinyl chloride resin contains an organotin stabilizer. The stabilizer included in each layer can improve weather resistance of the layer. A decrease in weather resistance results in release of layers in the sheet.

### SUMMARY OF THE INVENTION

As mentioned above, vinyl chloride resin film comprising a vanadate presents a problem since it deteriorates with the elapse of time. In particular, discoloration is a problem. In addition, other problems have been discovered in a vinyl chloride resin film comprising a vanadate when a protective film with light transmittance is adhered to the surface. Specifically, not only does the vinyl chloride resin film discolor due to the catalytic action of bismuth vanadate, but also the interlayer peel resistance between the vinyl chloride resin film and the protective film is impaired as the deterioration of vinyl chloride resin proceeds.

Preventing both the discoloration and the decrease of the interlayer peel resistance in the vinyl chloride resin film using known combinations of stabilizers has been difficult. It has therefore been necessary to discover a new combination effective for solving these problems.

The present invention solves the above problems and has an objective of providing a marking film of vinyl chloride resin containing a vanadate, being free from discoloration and, when a protective film is laminated, being free from a decrease in the interlayer peel resistance between the marking film and the protective film.

Specifically, the present invention provides the following marking films:

(1) A marking film comprising a vinyl chloride resin film containing a pigment and a stabilizer, characterized in that the pigment contains vanadate and that the stabilizer contains an organotin compound, a hindered amine type light stabilizer, and a metal soap.

(2) The above marking film, wherein the hindered amine type light stabilizer contains an N-methyl type hindered amine.

(3) The marking film described in (1) above, further comprising a light transmitting protective film adhered to one surface of the vinyl chloride resin film and an adhesive layer disposed on the other surface of the vinyl chloride resin film.

(4) The marking film described in (3) above, wherein the protective film is directly adhered to the vinyl chloride resin film.

### DETAILED DESCRIPTION OF THE PREFERRED EMBODIMENTS

The marking film in one embodiment of the present invention is a vinyl chloride resin film containing a pigment and a stabilizer, wherein the pigment contains a vanadate and the stabilizer contains an organotin compound, a hindered amine light stabilizer (HALS) and a metal soap as essential components. This composition effectively prevents a decrease in the interlayer peel resistance between a marking film (a vinyl chloride resin film) and a protective film adhered to the marking film, also prevents discoloration of the vinyl chloride resin film.

Although details of the action of the stabilizers used in the present invention are not fully known, the stabilizers are thought to decrease the catalytic action of vanadates, whereby the deteriorating reactions due to release of hydrogen chloride, growth of polyenes, and the like of vinyl chloride resin are suppressed. Specifically, the hindered amine light stabilizer effectively suppresses the photodeterioration reaction induced by vanadate as a catalyst, and the organotin compound and metal soap effectively suppress the heat deterioration reaction induced by vanadate as a catalyst, respectively. In addition, the organotin compound and metal soap exhibit their known actions of trapping released hydrogen chloride.

Therefore, hydrogen chloride migration to and accumulation at the interface of the vinyl chloride resin film and the protective film, as well as deterioration of the surface of the vinyl chloride resin film can be prevented. As a result, decrease in the interlayer peel resistance of the protective film from the vinyl chloride resin film can be effectively prevented even if the film is used for a long period of time outdoors. In addition, when bismuth vanadate pigment is used, it is possible to maintain vivid and strong color characteristics of the bismuth vanadate pigment for a long period of time, since discoloration (browning) of the vinyl chloride resin film due to polyene chain growth in the vinyl chloride resin is effectively prevented.

Furthermore, since the combination of an organotin compound and a metal soap is also effective as a heat stabilizer, the use of this combination can effectively prevent denaturing and discoloration when the marking film is produced by a process involving a heating operation (such as drying) at a comparatively high temperature (about 180-210° C.).

Although the above marking films comprise a vinyl chloride resin film containing a pigment and stabilizer, the marking film of the present invention may have a layered structure. For example, the marking film may have a three layer structure comprising a vinyl chloride resin film as a supporting body of the marking film, a light transmitting protective film adhered to one surface of the vinyl chloride resin film, and an adhesive layer disposed on the other surface of the vinyl chloride resin film.

The organotin compound used as a stabilizer in the vinyl chloride resin film of the marking film of the present invention is a compound having only an alkyl group and carboxyl group as organic functional groups bonded to the tin atom. Alkyl tin mercaptide compounds having a mercaptide group are excluded. The carboxylate group is shown by the formula —OCOR, wherein R is an alkyl group or alkenyl group. Preferably, R is an alkyl group having no unsaturated bonds.

Specific examples of the organotin compound include dialkyltin carboxylates and monoalkyltin carboxylates. Specific examples of the dialkyltin carboxylate include dibutyltin laurate, dibutyltin dilaurate, dimethyltin laurate, and dioctyltin laurate. Specific examples of the monoalkyltin carboxylate include monobutyltin laurate, monomethyltin laurate, and monooctyltin laurate.

The metal soup used as the stabilizer is a metal salt of a higher fatty acid. Either one metal salt can be used alone or two metal salts can be used in combination. Specific examples of the fatty acid include undecanoic acid, lauric acid, tridecanoic acid, myristic acid, palmitic acid, isostearic acid, stearic acid, 12-hydroxystearic acid, behenic acid, montanic acid, elaidic acid, oleic acid, linoleic acid, and linolenic acid. Zinc, calcium, cadmium, barium, and magnesium can be given as specific examples of the metal.

The stabilizers known as “hindered amine light stabilizers” (HALS) can be used in the present invention. They are the compounds having a hindered piperidine skeleton in the molecule. Specific examples of the hindered amine light stabilizer include bis-(2,2,6,6-tetramethyl-4-piperidyl)sebacate, bis-(N-methyl-2,2,6,6-tetramethyl-4-piperidyl)sebacate, bis-(1,2,2,6,6-pentamethyl-4-piperidyl)sebacate, 1,2,2,6,6-pentamethyl-4-piperidyl-tridecyl-1,2,3,4-butanetetracarboxylate, tetrakis-(2,2,6,6-tetramethyl-4-piperidyl)-1,2,3,4-butanetetracarboxylate, and tetrakis-(N-methyl-2,2,6,6-tetramethyl-4-piperidyl)-1,2,3,4-butanetetracarboxylate. Of these hindered amines, N-methyl hindered amines are preferable, because N-methyl hindered amines exhibit an excellent stabilizing effect (an effect of preventing a decrease in the interlayer peel strength between the vinyl chloride resin film and protective film and preventing discoloration of vinyl chloride resin film).

The total amount of stabilizers in the vinyl chloride resin film used in the marking film of the present invention is preferably 2-20 wt % (“percent by weight”), more preferably 3-15 wt %, and particularly preferably 5-13 wt % of the vinyl chloride resin (100 wt %) in the film. If it is below 2 wt %, the stabilization effect may be impaired; if it exceeds 20 wt %, characteristics of the vinyl chloride resin film (for example, capability of causing pigments to exhibit their inherent colors) may be impaired.

The content of each component in the stabilizer is preferably determined in a similar way. The amount of organotin compound is preferably 1-8 wt %, more preferably 1.5-7 wt %, and particularly preferably 2-6 wt % of the vinyl chloride resin (100 wt %) in the film. The amount of metal soap is preferably 0.1-2 wt %, more preferably 0.2-1 wt %, and particularly preferably 0.3-0.8 wt % of the vinyl chloride resin (100 wt %) in the film. The amount of hindered amine light stabilizer is preferably 0.2-4 wt %, more preferably 0.3-3 wt %, and particularly preferably 0.5-2 wt % in 100 wt % of the vinyl chloride resin in the film.

Stabilizers other than those mentioned above may also be included. In this instance, the content of the other stabilizers is preferably 50 wt % or less of the total amount of the stabilizers. An example of another type of stabilizer is a UV absorber. Examples of UV absorbers include cyanoacrylate UV absorbers, benzotriazole UV absorbers, benzophenone UV absorbers, and salicylate UV absorbers.

The amount of pigments including vanadates in the vinyl chloride resin film used in the marking film of the present invention is preferably 1-15 wt %, and more preferably 2-10 wt % of the vinyl chloride resin (100 wt %) in the film. The amount of vinyl chloride resin in the marking film is preferably 50-80 wt %.

The vinyl chloride resin film used for the marking film of the present invention may contain components other than the above stabilizers and pigments. Plasticizers, UV absorbers, antistatic agents, lubricants, dyes, pigments not containing a vanadate, surface improvers, and surfactants are given as examples of such other components.

Examples of the vinyl chloride resin forming the vinyl chloride resin film include vinyl chloride homopolymer, and copolymers of vinyl chloride such as vinyl chloride-propylene copolymers and vinyl chloride-vinyl acetate copolymer. The vinyl chloride resin can also form a mixture with a resin not containing vinyl chloride such as polypropylene and polyvinyl acetate. When resins other than vinyl chloride resins are included, the proportion of vinyl chloride in the total resin is preferably 60 wt % or more.

The marking film of the present invention is used for preparing an information display by adhering it to a signboard, guide plate, label board, and the like. In this instance, the information is displayed using characters and designs formed on the marking film in the following manner. First, an information display film is prepared by cutting another marking film or colored adhesive sheet in the shape of a character, design, or the like. The information display film thus prepared is adhered to the surface of the protective film of the marking film using an adhesive, thereby obtaining a marking film for information display. The information display film is preferably provided in advance with an adhesive layer like a marking film with an adhesive layer on one of the surfaces or an adhesive sheet. Lastly, the marking film for information display is adhered to a substrate to complete an information display body. One may use conventional methods for preparing the information display body from marking films, as a method for forming information displays by using cut information display films like this.

When a resin with high affinity for inks and toners (acrylic resin, polyurethane resin, phenoxy resin, etc.) is included in the protective film adhered to the marking film (or the protective film constituting the marking film), it is possible to print characters and designs on the protective film. In this case, a transparent adhesive sheet may be used as a protective layer to protect the printed characters and the like. In addition, it is possible to attach a protective film that covers the printed parts after the characters, designs, and the like have been printed on the surface of the marking film (the surface of the vinyl chloride resin film) of the present invention.

The marking film of the present invention can be manufactured by forming a resin composition containing prescribed components according to the method employed when forming conventional vinyl chloride resin films.

Forming methods such as calendaring, extrusion, and casting can be used for forming a raw material containing vinyl chloride resin, pigments, stabilizers, and other components into a film. In the case of casting, for example, a mixture of raw materials comprising the above components and a solvent is applied (cast) onto the film substrate and dried to form a film. A solvent that can form a sol vehicle in which fine particles of vinyl chloride resin are dispersed is preferably used. The raw material mixture to be cast can be obtained by dispersing pigments in the vehicle. The stabilizer is usually dissolved in the solvent, but may be present in the vehicle in the dispersed conditions. A common mixing apparatus such as a sand mill, propeller mixer, planetary mixer, or kneader can be used for preparing the raw material mixture.

A common method of application such as knife coating, bar coating, or roll coating can be used for casting. The drying temperature differs according to the type of solvent and is usually in the range of 150-210° C. The thickness of the vinyl chloride resin film after drying is usually 10-300 μm, and preferably 20-200 μm.

Either a processing substrate having a release layer or a protective film to be adhered to the marking film can be used as a film substrate in the casting process. The latter protective film is preferred because a laminated body of the vinyl chloride resin film and protective film can be easily fabricated.

The protective film adhered to the surface of the marking film or the light transmitting protective film adhered to the surface of the vinyl chloride resin film to form a layer structure marking film of the present invention is used to protect the surface of the supporting body from being damaged or soiled. The protective film is made from a light transmitting resin. Usually, the protective film is formed from a resin such as a fluoro resin, acrylic resin, polyester resin, polyurethane resin, phenoxy resin, or polyolefin resin, or a mixture of two or more of these resins. The resin forming the protective film preferably contains both a fluoro resin and an acrylic resin. When the resin contains a fluoro resin and an acrylic resin, the protective film exhibits well balanced adhesion to a vinyl chloride resin film, transparency, and staining resistance.

The fluoro resin is a fluorine-containing resin obtained by polymerizing a starting monomer containing at least one fluorine compound such as vinylidene fluoride, hexafluoropropylene, tetrafluoroethylene, or chlorotrifluoroethylene. The acrylic resin is an acrylic-based resin obtained by polymerizing an acrylic monomer such as methyl (meth)acrylate, ethyl (meth)acrylate, butyl (meth)acrylate, hydroxyethyl (meth)acrylate, or other (meth)acrylate monomers or a mixture of these monomers.

The protective film can be formed by applying and solidifying (drying or curing) a coating material containing a resin for the protective film by a conventional method. Specifically, the protective film is formed by directly applying the above coating composition to the surface of the vinyl chloride resin film used for the marking film or by applying the above coating composition to the release surface of the processing substrate. In the latter case, a separately formed vinyl chloride resin film can be adhered to the protective film formed on the processing substrate via an adhesion layer. However, the above-described method of adhering the vinyl chloride resin film and protective film by applying a composition for forming the vinyl chloride resin film to the protective film on a processing substrate and solidifying the coating by heating is more preferable.

The method of directly applying a composition for forming the vinyl chloride resin film to the protective film has an advantage of increasing adhesion of the vinyl chloride resin film and the protective film while omitting the step of separately forming an adhesion layer. This is also applicable to the case in which a coating composition for forming the protective film is applied to the surface of the vinyl chloride resin film. When the vinyl chloride resin film is directly adhered with the protective film without an adhesive layer between them, the interlayer peel resistance between the vinyl chloride resin film and the protective film may decrease if the vinyl chloride resin in the vinyl chloride resin film deteriorates. However, such a decrease in the interlayer peel resistance can be effectively prevented in the marking film of the present invention because the vinyl chloride resin film contains the above-mentioned stabilizers of the invention.

The thickness of the protective film is preferably 0.5-100 μm, and more preferably 1-70 μm.

The adhesive used in the adhesive layer provided on the surface of the marking film of the present invention or the adhesive layer provided on the surface of the vinyl chloride resin film to form a layer structure of the marking film usually comprises a tacky polymer and a crosslinking agent. The amount of crosslinking agent is preferably 0.1-5 parts by weight, and more preferably 0.15-3 parts by weight for 100 parts by weight of the tacky polymer in the adhesive.

The tacky polymer exhibits tackiness at an ambient temperature and can be used as a pressure-sensitive adhesive. Examples of such polymers include acrylic polymers, polyurethanes, polyolefins, and polyesters. In the same manner as in known pressure-sensitive adhesives, tackifiers can be used together with tacky polymers.

Synthesis of tacky polymers will now be described using an acrylic polymer as an example. First, an acrylic unsaturated acid such as acrylic acid, methacrylic acid, itaconic acid, or maleic acid is used as a first monomer. Then, a monomer mixture of the first monomer and an acrylic monomer, as a second monomer, is prepared. As the second monomer, an alkyl acylate such as iso-octyl acrylate, butyl acrylate, 2-ethylhexyl acrylate, and isononyl acrylate can be used. The ratio by weight of the first monomer and second monomer in the monomer mixture is preferably from 1:99 to 10:90.

The monomer mixture is synthesized into a tacky polymer with a prescribed molecular weight by a conventional polymerization method such as solution polymerization, emulsion polymerization, or bulk polymerization. The molecular weight of the tacky polymer may be in the range in which the polymer exhibits desired tackiness, usually 10,000-100,000 in weight average molecular weight.

As a crosslinking agent, an isocyanate compound, melamine compound, poly(meth)acrylate compound, epoxy compound, amide compound, bisamide compound such as a bisaziridine derivative of a dibasic acid (e.g. isophthaloylbis(2-methylaziridine), or the like can be used.

The adhesive layer is usually formed by applying a coating composition containing the above adhesive to the surface of the vinyl chloride resin film or the release surface of a release liner and solidifying the coating. When the adhesive layer is formed on the liner, the adhesive layer with the liner is applied to the vinyl chloride resin film with the adhesive layer being in contact with the vinyl chloride resin film, and pressed to closely adhere the adhesive layer to the vinyl chloride resin film surface. As a means of solidification; drying, curing, cooling (when the coating composition is a molten fluid), or the like can be used. As a means of coating, a roll coater, knife coater, bar coater, dye coater, or the like or a printing method such as screen printing or gravure printing can be used. The thickness of the adhesive layer is usually 10-200 μm, and preferably 15-150 μm.

### EXAMPLES

### Example 1

A light transmitting protective film was adhered to one surface of a vinyl chloride resin film and an adhesive layer was provided on the other surface of the vinyl chloride resin film to prepare a marking film with a three-layer structure. The following composition was used as a raw material mixture for forming the vinyl chloride resin film. “Geon® 178” manufactured by Geon Co of Avon Lake, Ohio, USA was used as the vinyl chloride resin.

As a yellow pigment, a bismuth vanadate pigment (“Irgacolor Yellow 2GLMA” manufactured by Ciba Specialty Chemicals Co. of Tarrytown, N.Y., USA) was used in an amount of 3.2 parts by weight for 100 parts by weight of the vinyl chloride resin. The following three types of stabilizer were used:

(a) A dibutyltin dilaurate heat stabilizer (“BT-11” manufactured by Asahi Denka Kogyo Co., Ltd.) in an amount of 4.5 parts by weight for 100 parts by weight of the vinyl chloride resin.

(b) A Ca—Zn metal soap heat stabilizer (“SC 1003” purchased from Asahi Denka Kogyo Co., Ltd. of Tokyo, Japan as a mixture of Ca metal soap and Zn metal soap) in an amount of 0.5 parts by weight for 100 parts by weight of the vinyl chloride resin.

(c) An N-methyl hindered amine light stabilizer, tetrakis-(1,2,2,6,6-pentamethyl-4-piperidyl)-1,2,3,4-butanetetracarboxylate (“LA-52” manufactured by Asahi Denka Kogyo Co., Ltd.) in an amount of 1 part by weight for 100 parts by weight of the vinyl chloride resin.

In addition to the above essential components, a polyester plasticizer (“PN-280” manufactured by Asahi Denka Kogyo Co., Ltd.), a cyanoacrylate UV absorber (“N-538” manufactured by BASF, 5 parts by weight for 100 parts by weight of the vinyl chloride resin), and an isoindolinone pigment were added (8 parts by weight for 19 parts by weight of bismuth vanadate).

A light transmitting film made from a mixture of an acrylic resin and fluoro resin was used as the protective film. Polymethyl methacrylate resin (“Elvacite 2021” manufactured by DuPont of Wilmington, Del., USA) was used as the acrylic resin and chlorotrifluoroethylene-vinylidene fluoride copolymer was used as the fluoro resin. The weight ratio of the acrylic resin and fluoro resin was 65:35.

The adhesive layer on the surface of the vinyl chloride resin film was formed from an adhesive containing an acrylic tacky polymer. A copolymer of 2-methylbutyl acrylate and acrylic acid (the ratio by weight of monomers=90:10) was used as the tacky polymer. Bisamide was added to the adhesive layer to crosslink the tacky polymer.

The marking film of Example 1 was prepared from the above components in the following manner:

(1) Preparation of coating composition for protective film: A mixture of the acrylic resin and fluoro resin at the above ratio was mixed and stirred in a solvent mixture of methyl ethyl ketone and toluene to obtain a coating composition.

(2) Preparation of coating composition for vinyl chloride resin film: The above components were mixed and stirred in a solvent mixture of xylene, diisobutyl ketone, and an aromatic solvent (“Solvesso 100” manufactured by Exxon Chemical of Houston, Tex., USA) to obtain a coating composition.

(3) Preparation of coating composition for adhesive layer: the tacky polymer and a corosslinking agent were mixed and stirred at a ratio by weight of 100:1.2.

(4) Preparation of marking film: The coating composition (1) above was applied to the release surface of a processing substrate (a PET film base) by bar coating. The coating was dried at 65° C. for one minute to obtain a protective film with a thickness of 3 μm. The coating composition prepared in (2) above was applied to the protective film by bar coating. The coating was dried at 65° C. for one minute, at 155° C. for 30 seconds, and at 205° C. for 90 seconds to obtain an intermediate laminate in which the protective film is directly stuck to the vinyl chloride resin film. The thickness of the vinyl chloride resin film was 50 μm. Next, the coating composition (3) was applied to the silicone coated release paper by bar coating and dried at 65° C. for 2 minutes and at 95° C. for 2 minutes to obtain an adhesive layer with a release coated paper with a thickness of 30 μm. Finally, the above intermediate laminate and the adhesive layer with the release coated paper was layered and pressed, and the processing substrate was removed to obtain the marking film of Example 1.

### Comparative Example 1

The marking film of Comparative Example 1 was obtained in the same manner as in Example 1, except that a dibutyltin mercaptide heat stabilizer (“1292” manufactured by Asahi Denka Kogyo Co., Ltd.) was used instead of the dibutyltin dilaurate heat stabilizer and the hindered amine light stabilizer was not used.

### Comparative Example 2

The marking film of Comparative Example 2 was obtained in the same manner as in Example 1, except that the N-methyl hindered amine light stabilizer was not used.

### Comparative Example 3

The marking film of Comparative Example 3 was obtained in the same manner as in Example 1, except that the dibutyltin dilaurate heat stabilizer was not used.

### Comparative Example 4

The marking film of Comparative Example 4 was obtained in the same manner as in Example 1, except that the Ca-Zn metal soap heat stabilizer was not used.

Evaluation

The release coated paper was removed from the marking films (each having a dimension of 40 mm×30 mm) of Example 1 and Comparative Examples 1-4 and a plate for inner luminescent signboard (“Panagraphics 945” series substrate manufactured by 3M Corp. of the US) was adhered to prepare a sample. This sample was tested using a metal accelerated weather resistance tester (“KU-R5” manufactured by DAIPLA WINTES Co., Ltd.) for 210 hours under the conditions of irradiation intensity of 70 Mw/cm2, a black panel temperature of 53° C., and humidity of 40% RH.

The samples after the 210 hour test were evaluated as follows. The evaluation results are shown in Table 1.

Color Change (Color Difference) of the Vinyl Chloride Resin Film (Supporting Material)

The color change (ΔE) was measured using a color meter (“CM-3700d” manufactured by Minolta Co., Ltd. of Osaka, Japan) at a view angle of 10 degrees using a light source D65. When the measured AE was less than 10, the vinyl chloride resin film was judged to have no color change and was rated as “Good”. When the measured ΔE was 10 or more, the vinyl chloride resin film was judged to have discoloration and was rated as “Bad”.

Interlayer Adhesion (Peeling Resistance) of the Vinyl Chloride Resin Film with the Protective Film

The surface of the protective film on the marking film was crosscut to evaluate the peeling resistance by a tape snap test. The film was crosscut to produce 100 squares, each having a dimension of about 1 mm×1 mm. Adhesive tape “610” manufactured by 3M Company (St. Paul, Minn.) was used.

When none of the crosscut squares of the protective film released from the vinyl chloride resin film, the interlayer peel resistance between the vinyl chloride resin film and protective film was judged to have not decreased and was rated as “Good”. When any one of the crosscut squares of the protective film released from the vinyl chloride resin film, the interlayer peel resistance between the vinyl chloride resin film and protective film was judged to have decreased and was rated as “Bad”.

TABLE 1

| | | | Accelerated weather | |
|---|---|---|---|---|
| | Stabilizer | | resistance test | |
| | | Light | Color | Interlayer |
| | Heat stabilizer | stabilizer | difference | adhesion |
| Example 1 | Laurate tin/ | N-methyl | Good | Good |
| | Ca—Zn metal | hindered | | |
| | soap | amine | | |
| Comparative | Mercaptide tin/ | None | Bad | Bad |
| Example 1 | Ca—Zn metal | | | |
| | soap | | | |
| Comparative | Laurate tin/ | None | Bad | Good |
| Example 2 | Ca—Zn metal | | | |
| | soap | | | |
| Comparative | Ca—Zn metal | N-methyl | Bad | Good |
| Example 3 | Soap | hindered | | |
| | | amine | | |
| Comparative | Laurate tin | N-methyl | Bad | Good |
| Example 4 | | hindered | | |
| | | amine | | |

In Table 1, “laurate tin” means dibutyltin dilaurate and “mercaptide tin” means dibutyltin mercaptide.

As demonstrated above, a marking film of vinyl chloride resin containing a vanadate, being free from discoloration and, when a protective film is laminated, being free from a decrease in the interlayer peel resistance between the marking film and the protective film, can be provided by the present invention.

1. A marking film comprising a vinyl chloride resin film containing a pigment and a stabilizer, characterized in that said pigment contains a vanadate and that said stabilizer contains an organotin compound, a hindered amine type light stabilizer, and a metal soap.

2. The marking film according to claim 1, wherein the hindered amine type light stabilizer contains an N-methyl type hindered amine.

3. The marking film according to claim 1, further comprising a light transmitting protective film adhered to one surface of said vinyl chloride resin film and an adhesive layer disposed on the other surface of said vinyl chloride resin film.

4. The marking film according to claim 3, wherein said protective film is directly adhered to said vinyl chloride resin film.
